(19) United States
(12) Patent Application Publication
(10) Pub. No.: US 2025/0335333 A1
(43) Pub. Date: Oct. 30, 2025

(54) ROBOT FOR SOFTWARE TESTING

(71) Applicant: UNITED STATES POSTAL SERVICE, Washington, DC (US)

(72) Inventors: Donald E. IRWIN, Fredericksburg, VA (US); Hossein M. KHAVARI, Clifton, VA (US); Stanley NOVACKI, Arlington, VA (US)

(21) Appl. No.: 19/185,661

(22) Filed: Apr. 22, 2025

Related U.S. Application Data
(60) Provisional application No. 63/638,007, filed on Apr. 24, 2024.

(51) Int. Cl. G06F 11/3604; B25J 9/16; G06Q 20/20

(52) U.S. Cl. CPC G06F 11/3612; B25J 9/1679; G06Q 20/208

(57) ABSTRACT

Techniques for automatically testing retail sale system software installed in a retail sale system computer are presented. The techniques use a testing system that includes a robot and an interface computer. The interface computer receives a peripheral device interaction instruction from the retail sale system computer generated by test software installed in the retail sale system computer, where the peripheral device interaction instruction corresponds to a physical interaction with a retail sale system peripheral device, translates the peripheral device interaction instruction into a robot control instruction, and provides the robot control instruction to the robot. The robot is in physical proximity with the retail sale system peripheral device. The robot accepts the robot control instruction and performs the physical interaction with the retail sale system peripheral device.

### RELATED APPLICATION

This application claims the benefit of U.S. Provisional Patent Application No. 63/638,007 entitled, “ROBOT FOR SOFTWARE TESTING,” filed Apr. 24, 2024, which is hereby incorporated by reference herein in its entirety.

### FIELD

This disclosure relates generally to robot-facilitated software testing.

### BACKGROUND

Retail sale systems, such as point of sale systems, typically include a number of components. For example, retail sale systems typically include a computer and one or more peripheral devices. Examples of such peripheral devices (also referred to herein as peripherals) include credit card readers, receipt printers, cash drawers, scales, check readers, and barcode scanners, among others. These peripheral devices are communicatively coupled to the computer, e.g., a personal computer, which coordinates communications with the peripherals and provides overall control of the retail sale system.

Retail sale system computers operate using highly complex retail sale system software. Such retail sale system software handles certain steps involved in the transactions that are effectuated using the retail sale system. Further, retail sale system software may process a retail sale transaction and handle communications with peripheral devices, such as a card reader peripheral device to process a credit card payment.

Robust testing of retail sale system software is generally warranted due to the complexity of such software and the highly undesirable effects caused when the retail sale system software does not function properly, such as inventory problems (e.g., inaccurate inventory figures, failure or lateness in reordering inventory, etc.), and negative financial and customer-satisfaction impacts due to mispricing or due to improper transaction steps (e.g., failing to weigh an item), among other things. In general, software that can test other software is known. However, existing testing software cannot by itself physically interact with retail sale system peripherals. Moreover, existing retail sale system peripherals, such as cash drawers, credit card readers, etc., are not capable of, nor are they designed for, interaction with software or testing software; instead the multitude of retail sale system peripherals that exist in real-world retail sale systems are designed to interact with human beings, making them unusable by testing software alone.

### SUMMARY

According to various embodiments, a testing system for automatically testing retail sale system software installed in a retail sale system computer is presented. The testing system includes: a robot; and an interface computer communicatively coupled to the retail sale system computer and the robot, the interface computer including a first electronic processor and a first non-transitory computer readable storage communicatively coupled to the first electronic processor, where the first non-transitory computer readable storage includes interface software, where the first electronic processor executes the interface software to perform actions including: receiving a peripheral device interaction instruction from the retail sale system computer generated by test software installed in the retail sale system computer, where the peripheral device interaction instruction corresponds to a physical interaction with a retail sale system peripheral device, translating the peripheral device interaction instruction into at least one robot control instruction, and providing the at least one robot control instruction to the robot; where the robot is in physical proximity with the retail sale system peripheral device, where the retail sale system peripheral device is communicatively coupled to the retail sale system computer, and where the robot accepts the at least one robot control instruction and performs the physical interaction with the retail sale system peripheral device.

Various optional features of the above system embodiments include the following. The testing system may include the retail sale system computer, the retail sale system computer including a second electronic processor and a second non-transitory computer readable storage communicatively coupled to the second electronic processor, where the second non-transitory computer readable storage includes: the retail sale system software, where the retail sale system software is executable by the second electronic processor to perform retail transactions, the test software, where the second electronic processor executes the test software to automatically perform a retail transaction operation using the retail sale system software, where the retail transaction operation includes the physical interaction with the retail sale system peripheral device, and facilitator software, where the second electronic processor executes the facilitator software to accept the peripheral device interaction instruction from the test software and provide the peripheral device interaction instruction to the interface computer. The facilitator software may include less than 50 lines of code that exposes a communication port of the retail sale system computer to the test software. The robot may include an end effector, and the end effector may include a suction cup, a gripper, and a stylus. The interface software may include a lookup table; and the translating the peripheral device interaction instruction into the at least one robot control instruction may include mapping the peripheral device interaction instruction to the at least one robot control instruction using the lookup table. The at least one robot control instruction may be defined by a human physically manipulating of the robot, and the peripheral device interaction instruction may include an alphanumeric string descriptive of at least one corresponding physical action. The physical interaction may include at least one of: a card swipe, a numeric touchpad entry, a script touchpad entry, a printout removal, a weight addition to a scale, a label scan, or a cash drawer closure. The retail sale system peripheral device may include one or more of: a card reader, a printer, a cash drawer, a physical keyboard, a scale, a check reader, or a scanner. The translating the peripheral device interaction instruction into the at least one robot control instruction may include parsing the peripheral device interaction instruction into a first plurality of individual control instructions, and the at least one robot control instruction may include a second plurality of robot control instructions. The interface computer may be communicatively coupled to the retail sale system computer over a serial port communication channel.

According to various embodiments, a method of automatically testing retail sale system software installed in a retail sale system computer is presented. The method uses: a robot in physical proximity with a retail sale system peripheral device, where the retail sale system peripheral device is communicatively coupled to the retail sale system computer, and an interface computer communicatively coupled to the retail sale system computer and the robot. The method includes: receiving, by the interface computer, a peripheral device interaction instruction from the retail sale system computer generated by test software installed in the retail sale system computer, where the peripheral device interaction instruction corresponds to a physical interaction with the retail sale system peripheral device; translating, by the interface computer, the peripheral device interaction instruction into at least one robot control instruction; and providing, by the interface computer, the at least one robot control instruction to the robot, where the robot accepts the at least one robot control instruction and performs the physical interaction with the retail sale system peripheral device.

Various optional features of the above method embodiments include the following. The method may include: performing, by test software executing in the retail sale system computer, a retail transaction operation using the retail sale system software executing in the retail sale system computer, where the retail transaction operation includes the physical interaction with the retail sale system peripheral device, accepting, by facilitator software executing in the retail sale system computer, the peripheral device interaction instruction from the test software; and providing, by the facilitator software, the peripheral device interaction instruction to the interface computer. The facilitator software may consist of less than 50 lines of code that exposes a communication port of the retail sale system computer to the test software. The robot may include an end effector, and the end effector may include a suction cup, a gripper, and a stylus. The interface software may include a lookup table; and the translating may include mapping the peripheral device interaction instruction to the at least one robot control instruction using the lookup table. The method may include defining, by a human physically manipulating of the robot, the at least one robot control instruction, where the peripheral device interaction instruction includes an alphanumeric string descriptive of at least one corresponding physical action. The physical interaction may include at least one of: a card swipe, a numeric touchpad entry, a script touchpad entry, a printout removal, a weight addition to a scale, a label scan, or a cash drawer closure. The retail sale system peripheral device may include one or more of: a card reader, a printer, a cash drawer, a physical keyboard, a scale, a check reader, or a scanner. The translating may include parsing the peripheral device interaction instruction into a first plurality of individual control instructions, and where the at least one robot control instruction includes a second plurality of robot control instructions. The interface computer may be communicatively coupled to the retail sale system computer over a serial port communication channel.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 illustrates a retail sale system together with an interface computer and a robot for testing the retail sale system software, according to various embodiments;

FIG. 2 illustrates an end effector of a robot for testing retail sale system software, according to various embodiments;

FIG. 3 illustrates pickup assembly for testing retail sale system software using a robot, according to various embodiments;

FIG. 4 is a schematic diagram of a system for testing retail sale system software using a robot, according to various embodiments; and

FIG. 5 is a flowchart for a method of testing retail sale system software using a robot, according to various embodiments.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

Some embodiments solve the problem of testing retail sale system software, and in particular, testing retail sale system software that requires physical interaction with a peripheral device(s). For example, some embodiments provide a robot that performs physical interactions with one or more retail sale system peripherals. Some embodiments may be used together with unmodified or slightly modified existing automated software-testing software. As a non-limiting example, existing software-testing software may automatically test retail sale system software by simulating operations, such as a retail sale transaction operation (e.g., a complete or partial sale). For such a test, the testing software may trigger the retail sale system cash drawer peripheral to open at the appropriate time, and the retail sale system may pause the transaction operation until the cash drawer is closed, which in existing conventional systems must be performed by a human being. After the cash drawer is physically closed, the retail sale system cash drawer peripheral sends a signal to the retail sale system computer that indicates that the cash drawer has been closed. According to some embodiments, a robot performs the required physical interactions; for example, the robot receives an indication from the automated software-testing software that the cash drawer requires closure, and the robot proceeds to physically close the cash drawer so that the software test may proceed. The robot according to various embodiments may physically interact with any of a variety of retail sale system peripherals, not limited to cash drawers. By way of non-limiting example, the robot according to various embodiments may interact with any, or a combination, of: a card reader, a printer, a cash drawer, a physical keyboard, a scale, a check reader, and/or a scanner. Thus, various embodiments may fully automate testing retail sale system software, including providing physical interactions with respective retail sale system peripheral devices.

These and other features and advantages are shown and described herein in reference to the figures.

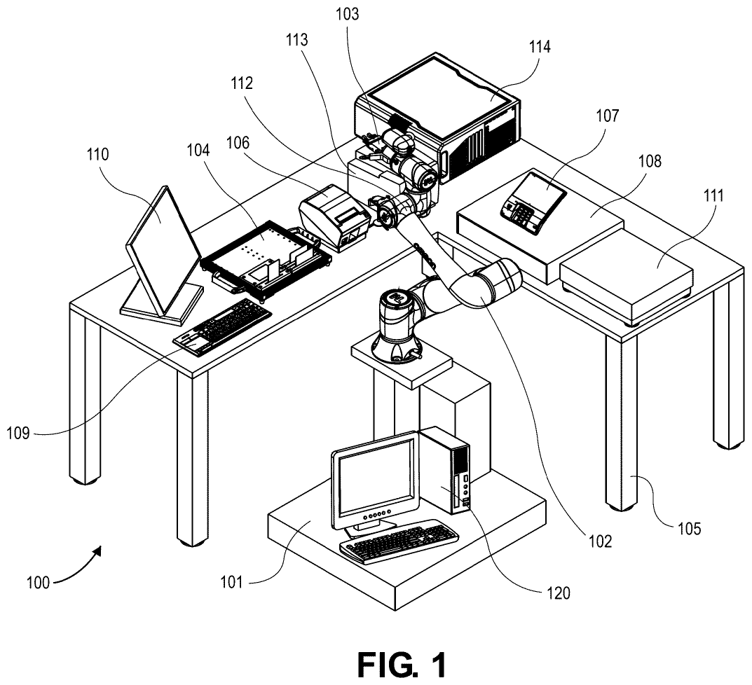

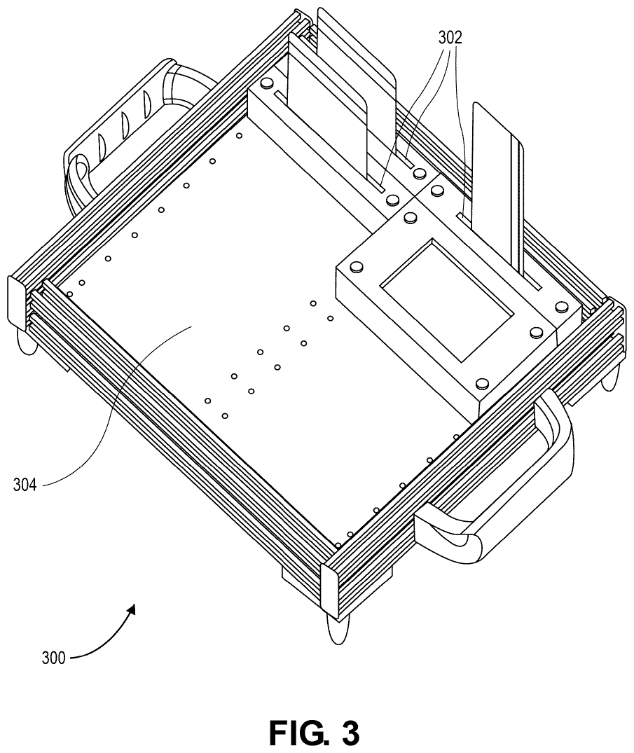

FIG. 1 illustrates a retail sale system 100 together with an interface computer 120 and a robot 102 for testing the retail sale system software, according to various embodiments. As shown in the example of FIG. 1, the retail sale system 100 includes a computer 114, by way of non-limiting example, a desktop personal computer, which includes a keyboard 109 and monitor 110. The computer 114 stores and executes retail sale system software, as shown and described in detail herein, e.g., in reference to FIG. 3. Further, according to some embodiments, the computer 114 stores and executes software-testing software and facilitator software, as shown and described in detail herein, e.g., in reference to FIG. 3.

By way of non-limiting example, the retail sale system 100 is shown disposed on an L-shaped desk 105. In addition to the computer 114, the retail sale system 100 includes retail system peripheral devices. As shown in FIG. 1, and by way of non-limiting example, such peripheral devices include a receipt printer 106, a card reader 107, a cash drawer 108, a scale 111, a scanner 112, and a check reader 113. The scanner 112 is shown in FIG. 1 as a barcode scanner (e.g., capable of scanning and interpreting UPC and QR codes), but may be any type of retail scanner, e.g., capable of scanning Stock-Keeping Unit (SKU) codes and the like.

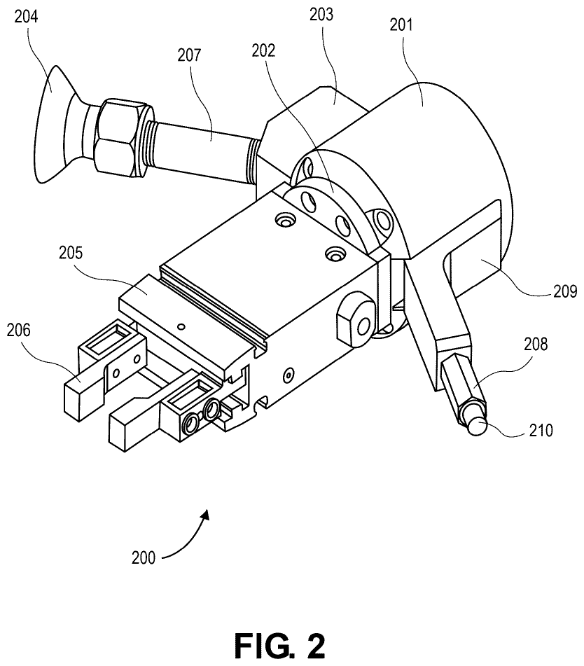

Also shown in FIG. 1 is a robot 102 disposed on a pedestal 101. The robot 102 may include a robot controller, which receives and process control signals or commands from the interface computer 120 that cause the robot 102 to physically move, and which may also transmit response signals that include information about the robot 102, such as status information, position information, error information, command completion information, etc. By way of non-limiting example, the robot 102 is shown in FIG. 1 as being implemented using a robotic arm. At the end of the robotic arm, the robot 102 includes an end effector 103, a non-limiting example of which is shown and described in detail herein in reference to FIG. 2. The end effector 103 may be configured and used to interact with the various peripheral devices (e.g., 109, 110, 104, 106, 113, 107, 111) in a manner similar to a human being; for example, the end effector 103 may be configured to pick up and return various items (e.g., a credit card) from a pickup assembly 104, which is shown and described in detail herein in reference to FIG. 3.

FIG. 2 illustrates an end effector 200/103 of a robot for testing retail sale system software, according to various embodiments. The end effector 200 may be affixed to the end of a robotic arm via its tooling base 201, e.g., the robotic arm implementation of the robot 102 as shown and described herein in reference to FIG. 1. The illustrated example of an end effector 200 is configured with three instruments for interacting with retail sale system peripherals.

In this example, the end effector 200 includes a gripper 205, which may be electrically powered, and which is affixed to the end effector 200 via a gripper adapter plate 202. The electric gripper 205 can grip (e.g., grasp, pickup, move, and/or release) various objects, such as credit cards, receipts, and checks, using its pincers 206.

As another example of an instrument, the end effector 200 includes a suction cup 204, which may be configured to release suction when desired, and which is affixed to the end effector 200 via a suction adapter plate 203 and thread adapter 207. The suction cup 204 is configured to pick up, move, and set down various smooth objects, such as credit cards, receipts, and checks.

As yet another example of an instrument, the end effector 200 includes a stylus touch tip 210, which is affixed to the end effector 200 via a touch adapter plate 209 and hex m-to-f adapter 208. The stylus touch tip 210 is configured to activate various mechanical and touch screen controls, including, for example, physical keyboards and keypads, virtual keyboards and keypads, and signature pads, in a manner similar to a human finger.

FIG. 3 illustrates pickup assembly 300/104 for testing retail sale system software using a robot, according to various embodiments. The pickup assembly may be utilized by a robot 102 for testing retail sale system software, such as is shown and described herein in reference to FIGS. 1 and 2. The pickup assembly 300 holds various items that the robot 102 may physically pick up, manipulate, and return, such as items that are used in retail sales transactions. By way of non-limiting example, the pickup assembly 300 may hold credit cards (which simulate the credit cards used by customers), money orders, letter envelopes, and/or checks, positioned to facilitate the gripper 205 of the robot end effector 200 physically grasping them. For example, one or more credit cards may be positioned in slots 302 that retain the cards in an upright position that allows the gripper 205 to easily pick them up and put them back. The pickup assembly 300 further includes a tray portion 304, which allows for the deposition and/or pickup of credit cards, checks, money orders, postage stamps, receipts, envelopes, or packages (e.g. to be shipped or mailed after weighing, etc.) by the gripper 205 or the suction cup 204 of the robot 102. For example, the robot 102 may pick up or retrieve a receipt from the receipt printer 106 and deposit it in the tray portion 304 using the gripper 205 or using the suction cup 204. For another example, the robot 102 may pick up a package from the tray portion 304 using the suction cup 204, place it on the scale 111 for weighing, and then return the package to the tray portion 304 after it is weighed.

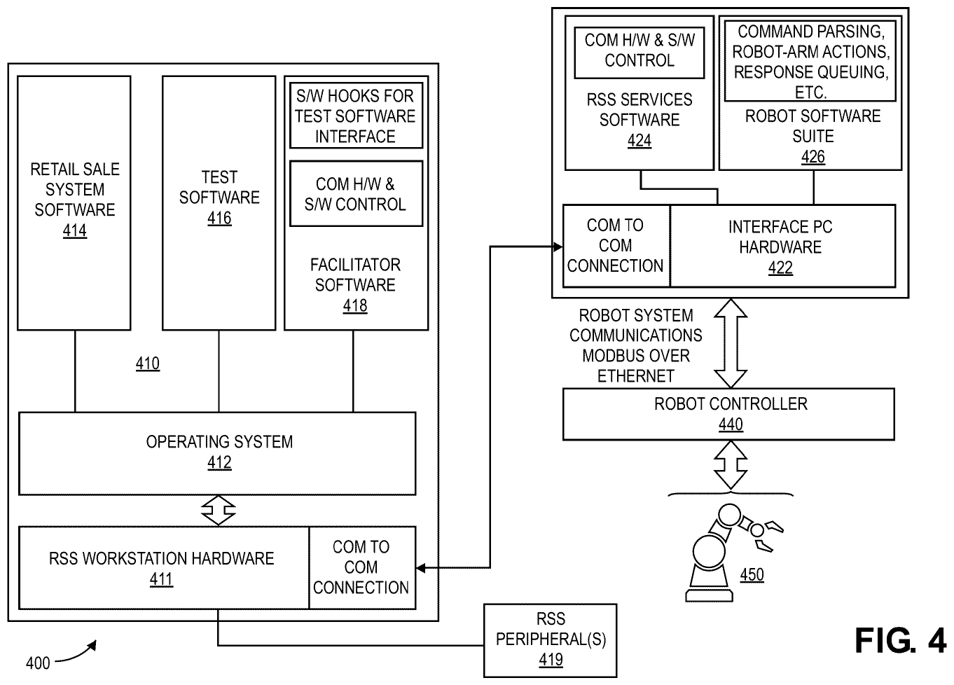

FIG. 4 is a schematic diagram of a system 400 for testing retail sale system software using a robot 102, according to various embodiments. As shown in the example of FIG. 4, the system 400 may be conceptualized as including three main parts. First, the system 400 may include a retail sale system computer 410/114 and one or more retail sale system peripheral devices 419, (e.g., 109, 110, 104, 112, 113, 107, 108, 111), which are communicatively coupled to the retail sale system computer 419, for example, by way of conventional peripheral attachment ports. Second, the system 400 may include a novel interface computer 420, which is communicatively coupled to the retail sale system computer, e.g., through a serial port connection 430. One advantage of the serial port connection 430 is that it is intrinsically more secure than, e.g., an ethernet connection. Third, the system 400 may include a novel robot 450/102 and robot controller 440. The robot controller 440 is communicatively coupled to both the interface computer 420 and to the robot 450, e.g., either or both of which may be by way of ethernet or IEEE 802.11 wireless connections. The robot 450 is disposed in physical proximity to the retail sale system peripheral device(s) 419, such that it can physically interact with the retail sale system peripheral device(s) 419, like a human being would. These three conceptual parts are described in detail presently.

The retail sale system computer 410 may be implemented as, by way of non-limiting example, a laptop or desktop personal computer. The retail sale system computer 410 includes retail sale system workstation hardware 411, e.g., a processor, volatile and persistent storage, etc. The retail sale system computer 410 operates under the control of an operating system 412, which may be any of a variety of known operating systems, e.g., UNIX, WINDOWS, etc.

The retail sale system computer 410 stores and executes retail sale system software 414. The retail sale system software 410 configures or causes the retail sale system computer 410 to perform retail transaction operations, such, by way of non-limiting examples: all or portions of retail sales, retail exchanges, or retail returns, and peripheral device actuations, such as cash drawer openings, printer jobs, waiting for credit card info from a reader, etc. For example, the retail sale system software 404 may configure the retail sale system computer 410 as a cash register, including interacting with and operating the connected retail sale system peripheral device(s) 419, which may include one or more of: a cash drawer (e.g., 108), a credit card reader (e.g., 107), a check or money order printer, a scale (e.g., 111), a scanner (e.g., 112), and a receipt printer (e.g., 111).

In the embodiment shown, the retail sale system computer 410 stores and executes automated software-testing software 416, which is also referred to herein as test software 416. The test software 416 may be software that is independent of, but interacts with, the retail sale system software 414. For example, the test software 416 may operate to automatically perform or simulate a series of retail transaction operations through the retail sale system software 414. For example, the test software 416 may provide inputs to the retail sale system software 414, e.g., in form fields provided by the retail sale system software 414. As another example, the test software 416 may activate any of a variety of virtual controls of the retail sale system software 414, e.g., virtual buttons, switches, sliders, etc. The test software 416 may detect any of a variety of failures of the retail sale system software 414. For example, the test software 416 may detect errors (such as operating system errors) generated by, or crashes of, the retail sale system software 414. For another example, the test software 416 may detect pricing errors associated with or caused by the retail sale system software 414, e.g., a pricing error that occurs when the retail sale system software 414 reads the wrong database to fetch the price of an item based on the item's barcode information that was read by the scanner 112. For yet another example, the test software 416 may detect peripheral-device-control errors associated with or caused by the retail sale system software 414, e.g., a failure by the retail sale system software 414 to send an “open” signal to the cash drawer 108 at the appropriate time.

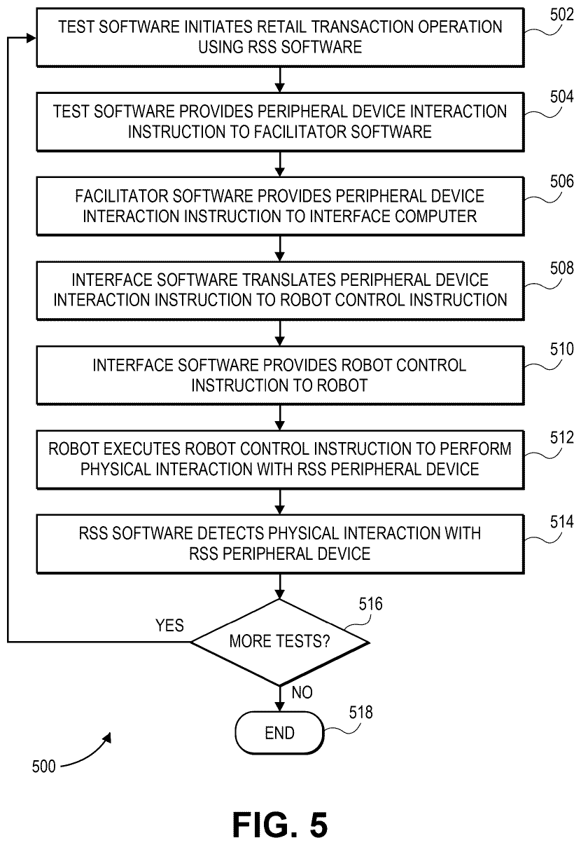

As described in detail herein, e.g., in reference to FIG. 5, the test software 416 includes, or is modified to include, code that generates and sends novel peripheral device interaction instructions to the interface computer 420 at various junctures during the software testing process. Each peripheral device interaction instruction corresponds to one or more physical interactions with one or more peripheral device(s) 419. That is, the peripheral device interaction instructions may be considered physical interaction instructions, because they specify physical interactions that need to be performed with one or more peripheral device in order for the retail sale system software 414 to function properly and realistically. These physical interactions are performed by the robot 450, whereas, as noted previously, in conventional systems, these physical interactions have to performed by a human, which is error-prone, slow, inefficient, costly, and tedious for the human. Non-limiting examples of a peripheral device interaction instructions include, “swipe a credit card,” “weigh a package,” “read a check,” “enter an address,” “pick up a receipt,” “put money in the cash drawer,” and “read a check.” In general, a peripheral device interaction instruction may be descriptive and in a human-readable textual format, such that the instructions can be easily understood and performed by a human, e.g., in conventional testing environment.

The retail sale system computer 410 further stores and executes novel facilitator software 418. The facilitator software 418 may be implemented as relatively simple code, such as a serial dynamic link library (DLL), that exposes a communication port of the retail sale system computer 410 so that the test software 416 can communicate with the interface computer 420, as described in detail herein. According to some embodiments, the facilitator software 418 may be implemented as 30-50 lines of C# code for a DOT NET instance that exposes a communication port of the retail sale system computer 410 to a Virtual Basic script. Thus, the facilitator software 418 may have a small footprint such that it does not interfere with the operation of the retail sale system software 414. As shown and described in detail herein, e.g., in reference to FIG. 5, the facilitator software 418 may receive a retail sale system peripheral device interaction instruction from the test software 416 and provide the peripheral device interaction instruction to the interface computer 420.

The interface computer 420 includes interface computer hardware 422, which operates under the control of an operating system. The interface computer 420 may be implemented as an independent personal computer, e.g., a laptop or desktop, or may be integrated with the robot controller 440, according to various embodiments. A benefit of embodiments that utilize an independent interface computer 420 is that the interface computer 420 may serve to isolate the retail sale system computer 410 from the robot 450 such that different robots 102/450 may be used or exchanged without having to modify any of the code or functionality of the retail sale system computer 410, which could cause unforeseen problems with the operation of the retail sale system computer 410. The interface computer 420 stores and executes retail sale system services software 424, which provides communication services between the interface computer 420 and the retail sale system computer 410. The interface computer 420 also stores and executes a robot software suite 426, which provides communication services between the interface computer 320 and the robot controller 440.

In general, the interface computer 420 translates or converts peripheral device interaction instructions received from the retail sale system computer 410 into robot control instructions, which it passes to the robot controller 440. In various embodiments, the translation of one type of instruction to the other may be performed by the retail sale system services software 424, by the robot software suite 426, or by a combination of the two. The robot control instructions may be conceptualized as the motions and operations the robot 450 is commanded to perform. In general, the robot control instructions may be in digital format and may not be human-readable.

In some embodiments, as part of the process of translating a particular peripheral device interaction instruction, the interface computer 410 may first use an intermediate step to convert a “coarse” peripheral device interaction instruction (e.g., an instruction to “swipe a credit card”) into a plurality of “fine” constituent peripheral device interaction instructions. For example, the “swipe a credit card” peripheral device interaction instruction may be converted or translated into three constituent instructions, such as: pick up card from slot #3 from the pickup assembly, swipe the card at the card reader, and return the card to the pickup assembly at slot #3. Depending on the particular robot 450 that is employed and its capabilities, either of “coarse” or “fine” peripheral device interaction instructions may be more desirable and/or practical.

As noted, the interface computer 420 determines the robot control instruction(s) that correspond to a particular peripheral device interaction instruction(s). In some embodiments, the interface computer 420 may include one or more lookup tables that store and associate peripheral device interaction instructions and/or constituent peripheral device interaction instructions with robot control instructions. In such embodiments, the interface computer 420 may translate a given peripheral device interaction instruction or constituent peripheral device interaction instruction into one or more robot control instructions by looking up the corresponding robot control instruction(s) in the lookup table(s). In other embodiments, other techniques and data structures may be used to the determine the robot control instruction(s) that correspond to a peripheral device interaction instruction.

Again depending on the particular robot 450 that is employed and its capabilities and control interface, the robot control instructions stored in the interface computer 420 may specify or correspond to a physical “routine” (e.g., a series of movements) that the robot 450 was previously trained to do, such as a routine for picking up a specific credit card from the pickup assembly 304, tapping the credit card on the card reader 107 so that the reader 107 can communicate with the card's chip, and replacing the credit card in the pickup assembly 304.

The robot controller 440 includes a processor, which accepts robot control instructions and provides corresponding robot control signals to the robot 450. The robot control signals may be conceptualized as electrical signals that operate the various actuators of the robot 440, such as motors and servos. In general, the robot control signals may be in analog electrical form.

The robot 450 may be implemented as a robot arm, e.g., as the robot 102 shown and described herein in reference to FIG. 1. For example, the robot 450 may include an end effector, such as the end effector 200 as shown and described herein in reference to FIG. 2. The robot 450 may be positioned in proximity to the peripheral device(s) 419, so that it may physically interact therewith. Further, the robot 450 may be positioned in proximity to one or more relevant objects, such as one or more credit cards, receipts, and/or checks. Such objects may be disposed on a pickup assembly(ies) in proximity to the robot 405, such as the pickup assembly 300 as shown and described herein in reference to FIG. 3.

Note that any of the retail transaction operations invoked by the test software 416 in the retail sale system software 414 may require a physical interaction with a retail sale system peripheral device 419. For example, a retail transaction operation may include a weighing operation, which may require picking up a package from a specific location (e.g., from a pickup assembly 300), placing the package on the scale for weighing, and picking up the package from the scale, and placing it back in the original location; and/or a payment processing operation, which may require payment by, for example, swiping a credit card in an attached card reader peripheral, before the retail sale system software 414 continues the retail transaction operation. However, the executing retail sale system software, by itself, cannot physically weigh a package or swipe a credit card. Therefore, in some embodiments, the test software 410 includes, or is modified to include, code that dispatches a peripheral device interaction instruction(s) to the interface computer 420 when a physical interaction with a peripheral device 419 is required. The peripheral device interaction instruction is indicative of the specific physical interaction(s) that is required by the retail transaction operation. The interface computer 420 accepts the peripheral device interaction instruction, and may process it to parse or convert one instruction into multiple constituent peripheral device interaction instructions. The interface computer 420 then translates the peripheral device interaction instruction and/or the constituent peripheral device interaction instructions into one or more robot control instructions, which it sends to the robot controller 440. The robot controller 440 generates and sends one or more corresponding robot control signals to the robot 450, which then performs the required physical interaction with the retail sale system peripheral device(s) 419. The retail sale system peripheral device 419 then typically sends a signal to the retail sale system computer 410 indicative of the completion of the physical interaction. The retail sale system software 414 may receive the signal from the peripheral device 419 and may then continue the retail sale transaction operation. Subsequently, the test of the retail sale system software 414 by the test software 416 may continue.

The process summarized above is further shown and described herein in reference to FIG. 5.

FIG. 5 is a flowchart for a method 500 of testing retail sale system software using a robot, according to various embodiments. The method 500 may be implemented using a system for testing retail sale system software using a robot, such as is shown and described herein in reference to FIGS. 1 and 2. For example, the method 500 may be implemented using the retail sale system 100 and robot 102 shown and described herein in reference to FIG. 1. As another example, the method 500 may be implemented using the system 400 shown and described herein in reference to FIG. 4. The method 500 shown and described in reference to FIG. 5 may form part of a full automated software test controlled by automated software-testing software. In general, the method 500 may include automated software-testing software (e.g., test software 416) performing an automated test of retail sale system software (e.g., retail sale system software 410), as shown and described herein in reference to FIG. 4.

At 502, the method 500 may include executing automated software-testing software (e.g., 416) initiating a retail transaction operation in the executing retail sale system software (e.g., 414) that is undergoing the automated test. The retail transaction operation may include, by way of non-limiting example, any, or any combination, of: a full retail sale, a full retail exchange, a full retail return, a partial retail sale, a partial retail exchange, a partial retail return, shipping an item (e.g., a letter, a package, etc.), issuing a money order, purchasing postage stamps, and/or a peripheral device actuation. The actions of 502 may include the automated software-testing software entering data into a field provided by the retail sale system software and/or the automated software-testing software activating any of a variety of virtual controls provided by the retail sale system software.

At 504, the method 500 may include the executing test software providing a peripheral device interaction instruction to facilitator software (e.g., 418). By way of non-limiting example, the test software may generate and provide the peripheral device interaction instruction at a juncture when the retail transaction operation initiated at 502 requires a physical interaction with one or more retail sale system peripheral devices, e.g., one or more retail sale system peripheral device(s) 419 as shown and described herein in reference to FIG. 4. The peripheral device interaction instruction may thus correspond to a required physical interaction with one or more retail sale system peripheral devices, which is typically performed by a human. The facilitator software of 504 may be implemented as the facilitator software 418 shown and described herein in reference to FIG. 4. For example, the facilitator software may have a small footprint and be stored and executed in the same retail sale system computer (e.g., 410) that stores and executes the retail sale system software that is being tested.

At 506, the executing facilitator software may provide the peripheral device interaction instruction to executing interface software. The facilitator software may expose a communication port of the retail sale system computer and provide the peripheral device interaction instruction to the interface computer via the exposed communication port.

At 508, the method 500 may include executing interface computer software (e.g., 424, 426) translating the peripheral device interaction instruction into at least one robot control instruction. The interface software may be stored and executed in a computer (e.g., 420) separate from the retail sale system computer and the robot controller, or, according to some embodiments, may be stored and executed in the robot controller (e.g., 440). According to some embodiments, the actions of 508 may proceed according to one or more of the following actions, which are described by way of explanation rather than limitation.

According to some embodiments, the interface computer may use a data structure, such as a stored lookup table, to determine one or more robot control instructions that are associated with, or that translate from the peripheral device interaction instruction. In other embodiments, techniques other than a lookup table may be used to translate or convert a peripheral device interaction instruction into a robot control instruction(s).

According to some embodiments, the interface computer (e.g., 420) may convert or parse the peripheral device interaction instruction into a plurality of constituent peripheral device interaction instructions. According to embodiments that perform such converting or parsing, the interface computer may use a stored lookup table to determine one or more respective robot control instructions that are associated with or correspond to each of the plurality of constituent peripheral device interaction instructions, such that a plurality of robot control instructions are provided. Each constituent peripheral device interaction instruction may correspond to one or more robot control instructions. In various embodiments, the lookup table for the constituent peripheral device interaction instructions may be the same as, or different from, the lookup table for the original peripheral device interaction instruction.

Thus, the actions of 508 may include providing one or more robot control instructions that correspond to the peripheral device interaction instruction provided at 506.

At 510, the method 500 may include the executing interface software for providing the one or more robot control instructions to the robot. The actions of 510 may include the interface software providing the one or more robot control instructions to the robot controller (e.g., 440), for example. The robot controller may then proceed to provide one or more corresponding robot control signals to the robot, such that the robot performs physical movements.

At 512, the method 500 may include the robot executing the one or more robot control instructions. The robot may execute the one or more robot control instructions to physically interact with one or more retail sale system peripheral devices (e.g., 419). By way of non-limiting example, the robot may swipe a credit card, remove a receipt, close a cash drawer, provide a script touchpad entry (e.g., a signature), activate a virtual or mechanical button (e.g., on the touchscreen monitor 110 or the keyboard 109), scan a code, and/or add or remove weight (e.g. a package or other item) from a scale (e.g., 111). In turn, the respective retail sale system peripheral device may provide a signal to the executing retail sale system software in the retail sale system computer indicating that the physical interaction with the one or more retail sale system peripheral devices has occurred, among other things. For example, in additional to, or functioning as, a signal indicating occurrence of a physical interaction with a peripheral device, the peripheral device may provide information that is used by the retail sale system software, such as credit card data, information from a scanned barcode, information from a scanned check, information on the weight of a package, etc.

At 514, the method 500 may include the executing retail sale system software detecting that the physical interaction with the retail sale system peripheral device has occurred. The retail sale system software may detect the interaction as a signal received from the retail sale system peripheral device in response to the robot performing the physical interaction at 512. As just noted, in some instances, the signal may include useful information from the peripheral device.

At 516, the method 500 may include a determination of whether additional tests are to be performed by the test software on the retail sale system software. If so, then control may revert to 502. If not, then control may pass to 518.

At 518, the method 500 may end.

Note that according to various embodiments, the method 500 may halt at any point if the test software detects any of a variety of events. Such events include, by way of non-limiting examples, an error generated by the retail sale system software (e.g., a variable out of bounds), a crash (e.g., unplanned stoppage) of the retail sale system software, a timeout (e.g., while waiting for a physical interaction with a retail sale system peripheral device) of the retail sale system software, an error (e.g., a collision detection) from the robot, or an error (e.g., an invalid peripheral device interaction instruction format) detected by the interface computer.

Certain examples can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), flash memory, and magnetic or optical disks or tapes.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented using computer readable program instructions that are executed by an electronic processor.

These computer readable program instructions may be provided to a processor of a general-purpose computer, special purpose computer, or other programmable data processing apparatus to produce a machine, such that the instructions, which execute via the electronic processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on a user's computer, partly on the user's computer, as a stand-alone software package, partly on the user's computer and partly on a remote computer or entirely on the remote computer or server.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A testing system for automatically testing retail sale system software installed in a retail sale system computer, the testing system comprising:
a robot; and
an interface computer communicatively coupled to the retail sale system computer and the robot, the interface computer comprising a first electronic processor and a first non-transitory computer readable storage communicatively coupled to the first electronic processor, wherein the first non-transitory computer readable storage comprises interface software, wherein the first electronic processor executes the interface software to perform actions comprising:
receiving a peripheral device interaction instruction from the retail sale system computer generated by test software installed in the retail sale system computer, wherein the peripheral device interaction instruction corresponds to a physical interaction with a retail sale system peripheral device,
translating the peripheral device interaction instruction into at least one robot control instruction, and
providing the at least one robot control instruction to the robot;
wherein the robot is in physical proximity with the retail sale system peripheral device,
wherein the retail sale system peripheral device is communicatively coupled to the retail sale system computer, and
wherein the robot accepts the at least one robot control instruction and performs the physical interaction with the retail sale system peripheral device.

2. The testing system of claim 1, further comprising the retail sale system computer, the retail sale system computer comprising a second electronic processor and a second non-transitory computer readable storage communicatively coupled to the second electronic processor, wherein the second non-transitory computer readable storage comprises:
the retail sale system software, wherein the retail sale system software is executable by the second electronic processor to perform retail transactions,
the test software, wherein the second electronic processor executes the test software to automatically perform a retail transaction operation using the retail sale system software, wherein the retail transaction operation includes the physical interaction with the retail sale system peripheral device, and
facilitator software, wherein the second electronic processor executes the facilitator software to accept the peripheral device interaction instruction from the test software and provide the peripheral device interaction instruction to the interface computer.

3. The testing system of claim 2, wherein the facilitator software comprises less than 50 lines of code that exposes a communication port of the retail sale system computer to the test software.

4. The testing system of claim 1, wherein the robot comprises an end effector, and wherein the end effector comprises a suction cup, a gripper, and a stylus.

5. The testing system of claim 1, wherein the interface software comprises a lookup table; and
wherein the translating the peripheral device interaction instruction into the at least one robot control instruction comprises mapping the peripheral device interaction instruction to the at least one robot control instruction using the lookup table.

6. The testing system of claim 5, wherein the at least one robot control instruction is defined by a human physically manipulating of the robot, and wherein the peripheral device interaction instruction comprises an alphanumeric string descriptive of at least one corresponding physical action.

7. The testing system of claim 1, wherein the physical interaction comprises at least one of: a card swipe, a numeric touchpad entry, a script touchpad entry, a printout removal, a weight addition to a scale, a label scan, or a cash drawer closure.

8. The testing system of claim 1, wherein the retail sale system peripheral device comprises one or more of: a card reader, a printer, a cash drawer, a physical keyboard, a scale, a check reader, or a scanner.

9. The testing system of claim 1, wherein the translating the peripheral device interaction instruction into the at least one robot control instruction comprises parsing the peripheral device interaction instruction into a first plurality of individual control instructions, and wherein the at least one robot control instruction comprises a second plurality of robot control instructions.

10. The testing system of claim 1, wherein the interface computer is communicatively coupled to the retail sale system computer over a serial port communication channel.

11. A method of automatically testing retail sale system software installed in a retail sale system computer, the method using:
a robot in physical proximity with a retail sale system peripheral device, wherein the retail sale system peripheral device is communicatively coupled to the retail sale system computer, and
an interface computer communicatively coupled to the retail sale system computer and the robot,
the method comprising:
receiving, by the interface computer, a peripheral device interaction instruction from the retail sale system computer generated by test software installed in the retail sale system computer, wherein the peripheral device interaction instruction corresponds to a physical interaction with the retail sale system peripheral device;
translating, by the interface computer, the peripheral device interaction instruction into at least one robot control instruction; and
providing, by the interface computer, the at least one robot control instruction to the robot, wherein the robot accepts the at least one robot control instruction and performs the physical interaction with the retail sale system peripheral device.

12. The method of claim 11, further comprising:
performing, by test software executing in the retail sale system computer, a retail transaction operation using the retail sale system software executing in the retail sale system computer, wherein the retail transaction operation includes the physical interaction with the retail sale system peripheral device,
accepting, by facilitator software executing in the retail sale system computer, the peripheral device interaction instruction from the test software; and
providing, by the facilitator software, the peripheral device interaction instruction to the interface computer.

13. The method of claim 12, wherein the facilitator software comprises less than 50 lines of code that exposes a communication port of the retail sale system computer to the test software.

14. The method of claim 11, wherein the robot comprises an end effector, and wherein the end effector comprises a suction cup, a gripper, and a stylus.

15. The method of claim 11, wherein the interface software comprises a lookup table; and
wherein the translating comprises mapping the peripheral device interaction instruction to the at least one robot control instruction using the lookup table.

16. The method of claim 15, further comprising defining, by a human physically manipulating of the robot, the at least one robot control instruction, wherein the peripheral device interaction instruction comprises an alphanumeric string descriptive of at least one corresponding physical action.

17. The method of claim 11, wherein the physical interaction comprises at least one of: a card swipe, a numeric touchpad entry, a script touchpad entry, a printout removal, a weight addition to a scale, a label scan, or a cash drawer closure.

18. The method of claim 11, wherein the retail sale system peripheral device comprises one or more of: a card reader, a printer, a cash drawer, a physical keyboard, a scale, a check reader, or a scanner.

19. The method of claim 11, wherein the translating comprises parsing the peripheral device interaction instruction into a first plurality of individual control instructions, and wherein the at least one robot control instruction comprises a second plurality of robot control instructions.

20. The method of claim 11, wherein the interface computer is communicatively coupled to the retail sale system computer over a serial port communication channel.
